(19) United States
(12) Patent Application Publication
(10) Pub. No.: US 2013/0016038 A1
(43) Pub. Date: Jan. 17, 2013

(54) MOTION DETECTION METHOD AND DISPLAY DEVICE

(71) Applicants: Shu-Han Yu, Taoyuan County (TW); Chia-Ho Lin, Hsinchu County (TW)

(72) Inventors: Shu-Han Yu, Taoyuan County (TW); Chia-Ho Lin, Hsinchu County (TW)

(21) Appl. No.: 13/400,582

(22) Filed: Feb. 21, 2012

(30) Foreign Application Priority Data
Jul. 14, 2011 (TW) 100124910

(51) Int. Cl. G06F 3/01

(52) U.S. Cl. 345/156

(57) ABSTRACT

A motion detection method for a display device includes the steps of capturing images from a position on the display device to generate a plurality of capture images, calculating a moving status of the display device according to the plurality of capture images, and adjusting a display range of the display device relative to an image data according to the moving status.

### BACKGROUND OF THE INVENTION

1. Field of the Invention

The present invention relates to a motion detection method and display device, and more particularly, to a motion-detection method utilizing image processing techniques and a related display device.

2. Description of the Prior Art

With the advancement of technology, there is an increasing diversity of input methods for electronic devices. For example, conventional methods utilize gyroscopes or gravity sensors to sense an accelerating motion of a portable electronic device in order to determine a moving status of the device and adjust a display range of the display device accordingly. Alternatively, the moving status may be utilized to determine an input character or command from the user. Such conventional methods primarily combine gravity sensors with gyroscopes to determine vertical and horizontal direction motion, respectively. Gravity sensors, however, are only capable of sensing a change in acceleration of the handheld device, and in turn deriving a motion displacement of the device. When the device is moving at a uniform speed, gravity sensors are unable to sense a movement path length, or discern slight differences in similar movement paths of the device with accuracy. Additionally, both gyroscopes and gravity sensors are mechanical components, and thus have a limited usage life, which makes them prone to becoming insensitive or malfunctioning. Moreover, mechanical components take up an excessive circuit area for the portable device, and components such as gyroscopes are also expensive for mass production.

Therefore, it is necessary to improve the conventional method of utilizing gyroscopes or gravity sensors for determining the moving status of electronic devices.

### SUMMARY OF THE INVENTION

A primary objective of the invention is to provide a motion detection method and a display device capable of determining a moving status of the display device without utilizing components such as gyroscopes or gravity sensors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a display device according to an embodiment of the invention.

FIG. 2 is a schematic diagram of the display device shown in FIG. 1 calculating a moving status according to a plurality of capture images.

FIG. 3 is a schematic diagram of the display device shown in FIG. 1 adjusting a display range relative to an image data.

FIG. 4 is a schematic diagram of a motion detection process according to an embodiment of the invention.

### DETAILED DESCRIPTION

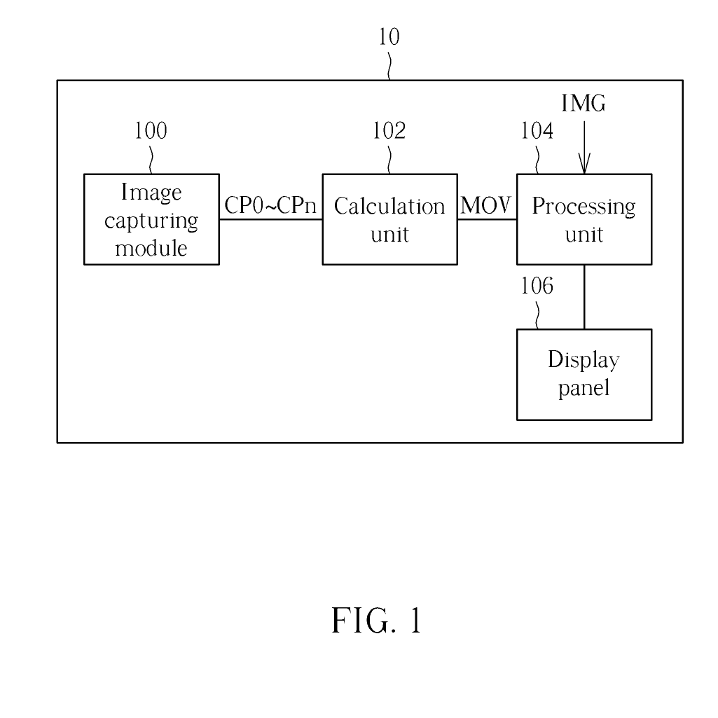

Please refer to FIG. 1, which is a functional block diagram of a display device 10 according to an embodiment of the invention. The display device 10 displays an image data IMG, and includes an image capturing module 100, a calculation unit 102, a processing unit 104, and a display panel 106. The image capturing module 100 continuously captures images from a specific position on the display device 10 to generate capture images CPO-CPn. The calculation unit 102 calculates a moving status of the display device 10 according to the capture images CPO-CPn, and generates a corresponding calculation result MOV. The processing unit 104 adjusts a display range of the display panel 106 relative to the image data IMG according to the calculation result MOV. In short, the display device 10 utilizes image processing techniques to calculate a moving status of the display device using the capture images CPO-CPn, and thus does not require additional sensors such as gyroscope or gravity sensors.

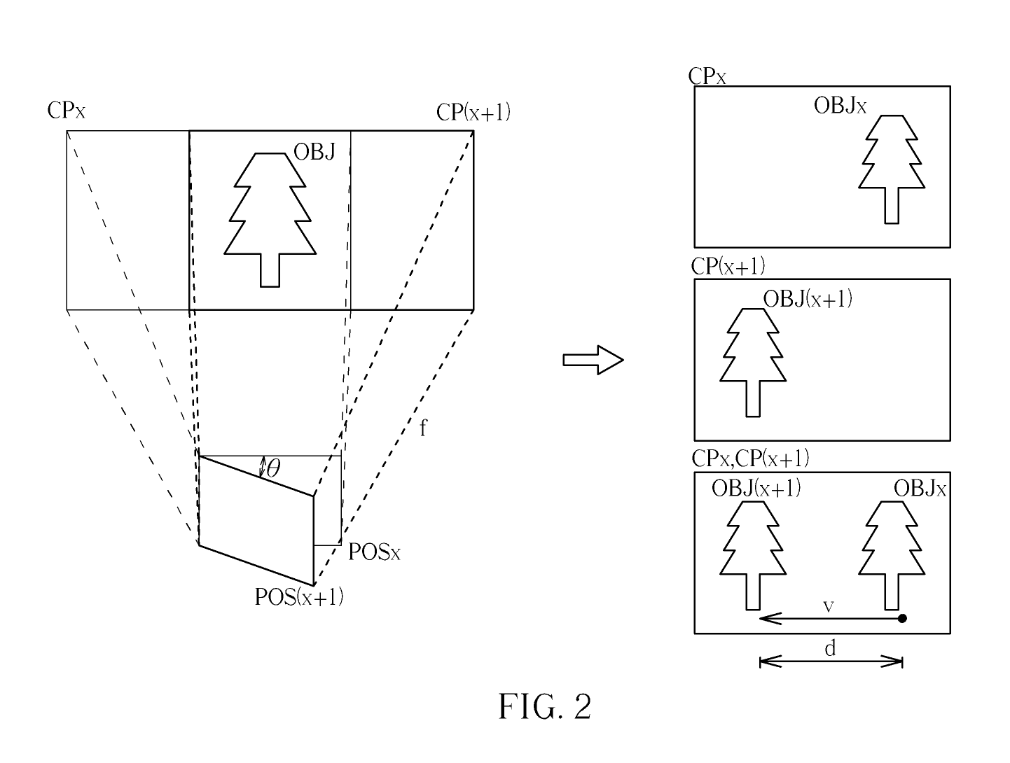

For more detail, please refer to FIG. 2, which is a schematic diagram of the display device 10 shown in FIG. 1 calculating the moving status according to the capture images CPO-CPn. Assume that the capture images CPx, CP(x+1) are two arbitrary, adjacent capture images within the capture images CPO-CPn captured by the image capturing module 100, corresponding to two capture images captured by the display device 10 from two different positions POSx, POS(x+1), respectively. An object OBJ is present in both of the capture images CPx, CP(x+1), and is denoted as OBJx, OBJ(x+1), respectively. A distance between the object OBJ and the display device 10 is a focal distance f of the image capturing module 100. The calculation unit 102 may generate a motion vector v according to a motion direction and distance of an image edge of the object OBJ in the capture images CPx, CP(x+1), respectively, and determine a moving status of the display device 10 according to the motion vector v. As shown in FIG. 2, in the capture images CPx, CP(x+1), the object OBJ is denoted OBJx, OBJ(x+1), respectively. It is possible to obtain a motion vector v according to the motion direction and distance of the image edge of the object OBJ in the capture images CPx, CP(x+1), respectively. Generating the motion vector v according to the motion direction and distance of the image edge is well-known to those skilled in the art, and may be accomplished via techniques such as edge detection, edge density map, etc., which are not described here. With FIG. 2 as an example, the motion vector v moves in a direction from OBJx towards OBJ(x+1) (from right to left), and a magnitude of the motion vector v is a distance d from OBJx to OBJ(x+1). As such, the calculation unit 102 may determine, according to the motion vector v, that the moving status of the display device 10 is a clockwise rotation by an angle θ on a horizontal plane. The rotation angle θ maybe further obtained via the distance d divided by the focal distance f. Note that FIG. 2 only illustrates an example wherein the calculation unit 102 determines that the moving status of the display device 10 is a rotation movement on a horizontal plane according to a one-dimensional motion vector v. In real applications, the motion vector v may also be a two-dimensional or three-dimensional vector, i.e. the calculation unit 102 may determine the moving status of the display device 10 is a translational or rotational movement in three-dimensional space according to a two-dimensional or three-dimensional motion vector, but is not limited thereto.

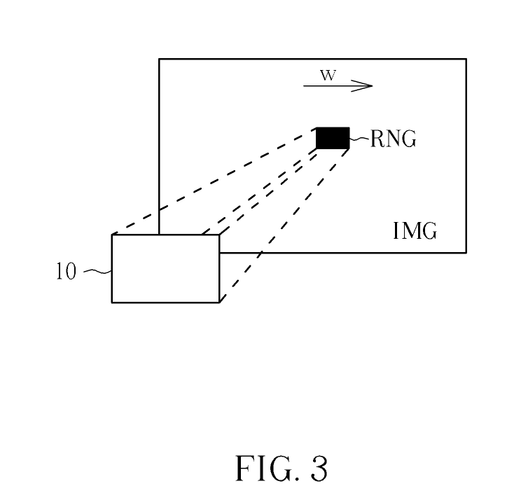

Please refer to FIG. 3, which is a schematic diagram of the display device 10 shown in FIG. 1 adjusting its display range RNG relative to the image data IMG. As shown in FIG. 3, after the calculation unit 102 determines that the display device 10 is rotating in a certain direction, the processing unit 104 moves the display range RNG of the display device 10 relative to the image data IMG according to a vector w, wherein a magnitude and direction of the vector w is related to the vector v. Preferably, the direction of the vector w is opposite to that of the motion vector v, and the magnitude of the vector w is directly proportional to that of the motion vector v. In the example shown in FIG. 2, the motion vector v has a direction of right-to-left, namely the moving status of the display device 10 is a clockwise rotation by an angle θ. Therefore, the processing unit 104 may move the display range RNG of the display device 10 relative to the image data IMG towards the right (i.e. the direction of the vector w is towards the right). The user may intuitively control a corresponding range of the image data IMG via suitably adjusting away in which the display device 10 is held (e.g. by turning the display device 10 in a certain direction).

Please note that the display device 10 is an embodiment of the invention, and modifications maybe made accordingly by those skilled in the art. For example, in the above-mentioned embodiment, the processing unit 104 generates a corresponding vector w to move the display range RNG of the display device 10 relative to the image data IMG according to the motion vector v. The magnitude and direction of the motion vector v correspond to a rotating direction and rotation angle θ of the display device 10; namely, the processing unit 104 decides how the display range RNG of the display device 10 moves relative to the image data IMG according to how much the display device 10 is rotated. An amount of rotation is merely one of many possible rotation characteristics, and the processing unit 104 may also decide how the display range RNG of the display device 10 moves relative to the image data IMG according to other motion characteristics of the display device 10, e.g. translational displacement, speed, and acceleration, or other rotation characteristics such as angular displacement, angular speed, and angular acceleration. In the above-mentioned embodiment, it may be assumed that the image capturing module 100 continuously captures images from the specific position on the display device 10 to generate the capture images CPO-CPn at a capturing time interval t. It follows that the calculation unit 102 may further obtain rotational properties of the display device 10 such as angular speed and angular acceleration via the time interval t and the rotation angle θ of the display device 10. As such, the processing unit 104 may decide different ways in which the display range RNG of the display device is moved relative to the image data IMG according to different rotation characteristics of the display device 10. For example, the processing unit 104 may move the display range 110 at different speeds corresponding to the rotation speed of the display device 10. In this way, the user is able to rapidly view different parts of the image data IMG via quickly rotating the display device 10. Furthermore, when the rotational acceleration of the display device 10 reaches a specific value, it is also possible for the processing unit 104 to move the display range RNG accordingly, such as scrolling the display range 110 in a specific direction to a border of the image data IMG. Additionally, the display device 10 may have multiple modes of operation, e.g. a capture mode and a playback mode. During the capture mode, the image data IMG may be an image data being captured by the image capturing module 100, and during the playback mode, the image data IMG may be an image data previously stored in the display device 10.

A source of the image data IMG is not limited to the above. Furthermore, corresponding actions generated by the processing unit 104 according to the moving status of the display device 10 are not limited to moving the display range RNG of the display device 10. Alternatively, the actions may correspond to different operations of a user interface of the display device 10. For example, the user may perform a page-flip operation on the user interface of the display device 10 via rotating the display device 10. However, actions generated by the processing unit 104 according to the moving status of the display device 10 are not limited thereto, and those skilled in the art may make suitable modifications accordingly.

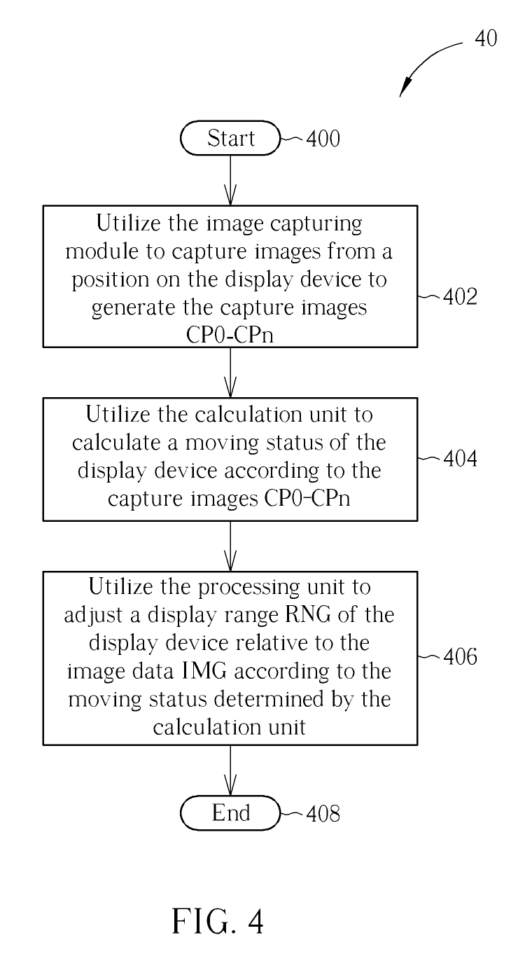

Operations of the display device 10 may be further summarized into a motion detection process 40, as shown in FIG. 4. The motion detection process 40 includes the following steps:

Step 400: Start;

Step 402: Utilize the image capturing module 100 to capture images from a position on the display device 10 to generate the capture images CPO-CPn;

Step 404: Utilize the calculation unit 102 to calculate a moving status of the display device 10 according to the capture images CPO-CPn;

Step 406: Utilize the processing unit 104 to adjust a display range RNG of the display device 10 relative to the image data IMG according to the moving status determined by the calculation unit 102;

Step 408: End.

Detailed descriptions for the motion detection process 40 can be found in the above, and are therefore not repeated here.

In summarize, the invention utilizes image processing techniques to calculate the motion of a display device via a plurality of capture images, and thus does not require extra sensor components such as gyroscopes and gravity sensors. In this way, it is possible to accurately determine the moving status of an electronic device, and reduce production costs and circuit size at the same time. Moreover, durability and sensor failure are also improved through elimination of mechanical components.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motion detection method for a display device, the motion detection method comprising:
capturing images from a position of the display device to generate a plurality of capture images;
calculating a moving status of the display device according to the plurality of capture images; and
adjusting a display range of the display device relative to an image data according to the moving status.

2. The motion detection method of claim 1, wherein the step of calculating the moving status of the display device according to the plurality of capture images comprises:
comparing at least two adjacent capture images of the plurality of capture images;
determining a motion direction and distance of an image edge in the adjacent capture images to generate a motion vector; and
determining the moving status of the display device according to the motion vector.

3. The motion detection method of claim 1, wherein the step of adjusting the display range of the display device relative to the image data according to the moving status comprises:
moving the display range of the display device relative to the image data in a specific direction when the moving status indicates that the display device is moving in the specific direction.

4. The motion detection method of claim 3 further comprising:
deciding how the display range of the display device moves relative to the image data in the specific direction according to a translational characteristic of the moving status of the display device.

5. The motion detection method of claim 4, wherein the translational characteristic is one of translational speed, translational acceleration, or translational displacement.

6. The motion detection method of claim 3 further comprising:
deciding how the display range of the display device moves relative to the image data in the specific direction according to a rotational characteristic of the moving status of the display device.

7. The motion detection method of claim 6, wherein the rotational characteristic is one of rotational speed, rotational acceleration, or rotational displacement.

8. The motion detection method of claim 1 further comprising:
performing an action on a user interface of the display device according to the moving status.

9. A display device for displaying an image data, the display device comprising:
an image capturing module, for generating a plurality of capture images;
a calculation unit, for calculating a moving status of the display device according to the plurality of capture images; and
a processing unit, for adjusting a display range of the display device relative to the image data according to the moving status.

10. The display device of claim 9, wherein the calculation unit compares at least two adjacent capture images of the plurality of capture images and determines a motion direction and distance of an image edge in the adjacent capture images to generate a motion vector, and determines the moving status of the display device according to the motion vector.

11. The display device of claim 9, wherein the processing unit moves the display range of the display device relative to the image data in a specific direction when the moving status indicates that the display device is moving in the specific direction.

12. The display device of claim 11, wherein the processing unit further decides how the display range of the display device moves relative to the image data in the specific direction according to a translational characteristic of the moving status of the display device.

13. The display device of claim 12, wherein the translational characteristic is one of translational speed, translational acceleration, or translational displacement.

14. The display device of claim 11, wherein the processing unit further decides how the display range of the display device moves relative to the image data in the specific direction according to a rotational characteristic of the moving status of the display device.

15. The display device of claim 14, wherein the rotational characteristic is one of rotational speed, rotational acceleration, or rotational displacement.

16. The display device of claim 9, wherein the processing unit further performs an action on a user interface of the display device according to the moving status.
